(19) United States
(12) Patent Application Publication
(10) Pub. No.: US 2017/0279283 A1
(43) Pub. Date: Sep. 28, 2017

(54) APPARATUS AND METHOD OF BALANCE CHARGING BATTERY PACK USING CHARGE CHARACTERISTIC CURVE

(71) Applicant: IBT Co., Ltd., Gwangju (KR)

(72) Inventors: Hoon KIM, Gwangsan-gu (KR); Jae Young CHO, Yeonggwang-gun (KR); Chan Ho CHO, Seoul (KR); Yang Im AN, Boseong-gun (KR)

(21) Appl. No.: 15/437,784

(22) Filed: Feb. 21, 2017

(30) Foreign Application Priority Data
Mar. 25, 2016 (KR) 10-2016-0036252

(51) Int. Cl. H02J 7/00

(52) U.S. Cl. CPC H02J 7/0019; H02J 7/0021

(57) ABSTRACT

The present invention relates to an apparatus and method of balance charging a plurality of battery cells serially connected to each other. The apparatus for balance charging the battery pack includes: a charger supplying a charge current to a plurality of battery; a voltage sensor sensing cell voltages of the plurality of battery cells; an integrated controller determining whether or not to perform a balance process and detecting a target battery cell to be balanced;

balance resistors and switching elements, each of the balance resistors and switching elements being respectively connected to the plurality of battery cells in parallel; a balance controller controlling a switching element connected to the target battery cell to be balanced, thereby the cell voltage of the target battery cell is consumed by an associated balance resistor; and a charge current controller decreasing the charge current output from the charger.

### CROSS REFERENCE TO RELATED APPLICATION

The present application claims priority to Korean Patent Application No. 10-2016-0036252, filed Mar. 25, 2016, the entire contents of which is incorporated herein for all purposes by this reference.

### BACKGROUND OF THE INVENTION

Field of the Invention

The present invention generally relates to an apparatus for balance charging a battery pack. More particularly, the present invention relates to an apparatus and method of balance charging a plurality of battery cells serially connected to each other by using a charge characteristic curve of a lithium ion phosphate battery.

Description of the Related Art

Generally, secondary batteries are classified into: a nickel-cadmium cell, a nickel-hydride battery, a lithium-ion battery, a lithium-ion polymer battery, etc. Such secondary batteries are classified again into a lithium based secondary battery and a nickel-hydride based battery.

A plurality of battery cells that are serially connected to each other is constituted in a package and is used for an energy storage system (ESS) that requires a high voltage output and for electrical vehicles. Voltage differences occur between the battery cells due to a chemical difference and a physical property difference between each of the battery cells constituting the package. In particular, the battery cells begin to deteriorate due to continuous charges/discharges. However, since each deterioration degree of the battery cells is different, each of the battery cells is charged and discharged at a different time, and charge and discharge amounts thereof are also different. Charge and discharge times of the battery cell where deterioration is relatively progressed is shorter than other battery cells, thus the battery cell is fully-charged and fully-discharged first. In addition, charging and discharging of battery cells that are relatively less degraded are finished before they are fully-charged or fully-discharged.

When the above situation is neglected and the battery cell is continuously charged and discharged, the deterioration degree of the battery cell progressively becomes worse, and cell voltage of the battery having a low voltage is further lowered. As a result, it may cause ignition or explosion of the secondary batteries. In addition, the whole battery pack may need to be replaced due to the unit battery cell, thereby causing an economical loss.

In order to solve the above problem, a battery cell balancing is applied to the battery pack. Battery cell balancing refers to charging battery cells that are serially connected to each other while maintaining voltage differences between the battery cells within a predetermined range. As a conventional method of battery cell balancing, a passive cell balancing method that uses a method of discharging by using a resistor, and an active cell balancing method that uses a DC converter are well known.

Meanwhile, FIG. 1 shows a charge characteristic curve and a discharge characteristic curve of a lithium ion phosphate battery. When 10% of a battery capacity is charged as the battery is charged, an output of the battery is increased to 3.2V (referred to a “low voltage rising range”). Above 85% of the battery capacity is charged when the output of the battery becomes within 3.2V˜3.4V (referred to a “flatness range”). In order to charge the remaining 15% of the battery capacity, the output of the battery is rapidly increased up to 3.9V (referred to a “high voltage rising range”). In other words, the lithium ion phosphate battery is fully-charged by passing the low voltage rising range, the flatness range, and the high voltage rising range.

In the conventional passive cell balancing method, cell voltages are sensed in real time, and when a maximum cell voltage is equal to or greater than a balance voltage (generally, 3.7V), the cell voltage of the corresponding cell is discharged by a discharging resistor and is balanced to cell voltages of other cells. However, when the balance voltage belongs to the high voltage rising range, and even though the cell voltage is decreased by discharging the cell voltage through generating a balance current, a voltage that is charged by a charge current is larger than a voltage that is discharged by the balance current. Thus, the cell voltage of the battery continuously increases since the balancing current is much smaller than the charge current.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) WIPO Publication No. W02012/124845;

(Patent Document 2) Japanese Patent Application No. 2008-233966; and

(Patent Document 3) Japanese Patent Application No. 2003-413965.

### SUMMARY OF THE INVENTION

Accordingly, the present invention has been made keeping in mind the above problems occurring in the related art, and an object of the present invention is to propose an apparatus and method of balance charging a battery pack, the apparatus and method being capable of performing a cell balance process based on a voltage difference between a maximum cell voltage and a minimum cell voltage after at least one battery cell of a battery pack, wherein a plurality of battery cells are serially connected to each other, has entered a high voltage rising range, and improving cell balance efficiency by interlocking with charge current.

In addition, another object of the present invention is to provide an apparatus and method of balance charging a battery pack, the apparatus and method capable of deriving failure probabilities of battery cells and switching elements by collecting and analyzing information about a battery cell on which the cell balancing process is performed.

In order to achieve the above object, according to one aspect of the present invention, there is provided an apparatus for balance charging a battery pack, the apparatus including: a charger supplying a charge current to a plurality of battery cells that are serially connected to each other; a voltage sensor sensing cell voltages of the plurality of battery cells; an integrated controller determining whether or not to perform a balance process and detecting a target battery cell to be balanced by using the sensed cell voltages of the plurality of battery cells received from the voltage sensor; balance resistors and switching elements, each of the balance resistors and switching elements being respectively connected to the plurality of battery cells in parallel; a balance controller, being controlled by the integrated controller, controlling a switching element connected to the target battery cell to be balanced, thereby the cell voltage of the target battery cell is consumed by an associated balance resistor; and a charge current controller, being controlled by the integrated controller, decreasing the charge current output from the charger while the balance process is performed, wherein the integrated controller detects whether or not the cell voltages of the battery cells enter respective high voltage rising ranges based on rates of cell voltage increase in the battery cells, controls the balance controller and the charge current controller by detecting the target battery cell to be balanced based on a voltage difference between the cell voltage of a battery cell that has entered the high voltage raising range and the cell voltage of a battery cell having a minimum cell voltage, diagnoses deterioration states of the plurality of battery cells by periodically storing voltage values entering the high voltage rising ranges corresponding to the rates of cell voltage increase in the battery cells that have entered the high voltage rising ranges, and diagnoses failures of the target battery cell to be balanced and the switching element connected thereto by storing information about the target battery cell to be balanced.

In addition, according to another aspect of the present invention, there is provided a method of balance charging a battery pack of an apparatus for balance charging a battery pack, whereby the apparatus includes: a charger supplying a charge current to a plurality of battery cells that are serially connected to each other; a voltage sensor sensing cell voltages of the plurality of battery cells; an integrated controller determining whether or not to perform a balance process and detecting a target battery cell to be balanced by using the sensed cell voltages of the plurality of battery cells received from the voltage sensor; balance resistors and switching elements, each of the balance resistors and switching elements respectively connected to the plurality of battery cells in parallel; a balance controller, being controlled by the integrated controller, controlling a switching element connected to the target battery cell to be balanced, thereby the cell voltage of the target battery cell is consumed by an associated balance resistor; and a charge current controller, being controlled by the integrated controller, decreasing the charge current output from the charger while the balance process is performed, the method being performed by the integrated controller and including: detecting whether or not the cell voltages of the battery cells enter respective high voltage rising ranges based on rates of cell voltage increase in the battery cells; detecting the target battery cell to be balanced based on a voltage difference between the cell voltage of a battery cell that has entered the high voltage rising range and a cell voltage of the battery cell having a minimum cell voltage; discharging the cell voltage of the target battery cell to be balanced and decreasing the charge current by controlling the balance controller and the charge current controller when the target battery to be balanced is detected; diagnosing deterioration states of the plurality of battery cells by periodically storing voltage values entering the high voltage rising ranges corresponding to the rates of cell voltage increase in the battery cells that have entered the high voltage rising ranges; and diagnosing failures of the battery cell and the switching element by storing information about the target battery cell to be balanced.

As described above, according to the present invention, effect of the cell balance process is maximized since the charge current is decreased by interlocking with the charger while performing the cell balance process.

In addition, when the battery pack fails, a failure thereof is easily diagnosed by collecting and analyzing information about the battery cell into which the cell balancing process is performed and deriving failure probabilities of the target battery cell to be balanced and the switching element associated thereto.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing a charge characteristic curve and a discharge charge characteristic curve of a lithium ion phosphate battery;

FIG. 2 is a block diagram showing a battery charge system including a battery balance device according to an embodiment of the present invention; and

FIG. 3 is a flowchart showing an operation of an integrated controller according to the present invention.

### DETAILED DESCRIPTION OF THE INVENTION

Hereinafter, an apparatus and method of balance charging a battery pack according to an embodiment of the present invention will be described in detail with reference to the accompanying drawings.

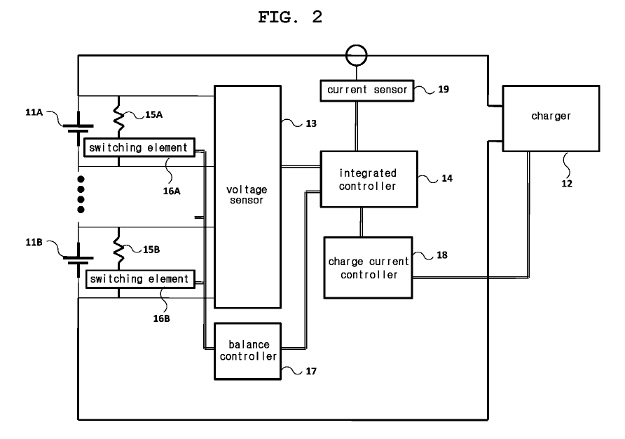

FIG. 2 is a block diagram showing a battery charge system including a battery balance device according to an embodiment of the present invention.

The battery charge system according to the present invention includes: a charger 12 supplying charge current to a plurality of battery cells 11A and 11B that are serially connected to each other; a voltage sensor 13 sensing cell voltages of the plurality of battery cells; an integrated controller 14 determining whether or not to perform a balance process and detecting a target battery cell to be balanced by using the sensed cell voltages received from the voltage sensor 13; balance resistors 15A and 15B and switching elements 16A and 16B, each of the balance resistors 15A and 15B and the switching elements 16A and 16B respectively connected to the plurality of battery cells 11A and 11B in parallel; a balance controller 17, being controlled by the integrated controller 14, turning on/off a switching element that is connected to target battery cell, thereby the cell voltage of the target battery cell is consumed by an associated balance resistor; a charge current controller 18, being controlled by the integrated controller 14, decreasing the charge current output from the charger 12 while the balance process is performed. In addition, the battery charge system according to the present invention further includes a current sensor 19 sensing an amount of current supplied from the charger 12 to the plurality of battery cells 11A and 11B.

Operations of the battery charge system and the battery balance device configured as described above will be described.

The charger 12 generates and supplies charge current to the plurality of battery cells 11A and 11B that are serially connected to each other. The plurality of battery cells 11A and 11B is charged by the charge current. The voltage sensor 13 respectively senses cell voltages of the plurality of battery cells 11A and 11B, and provides cell voltage information of each of the plurality of battery cells 11A and 11B to the integrated controller 14.

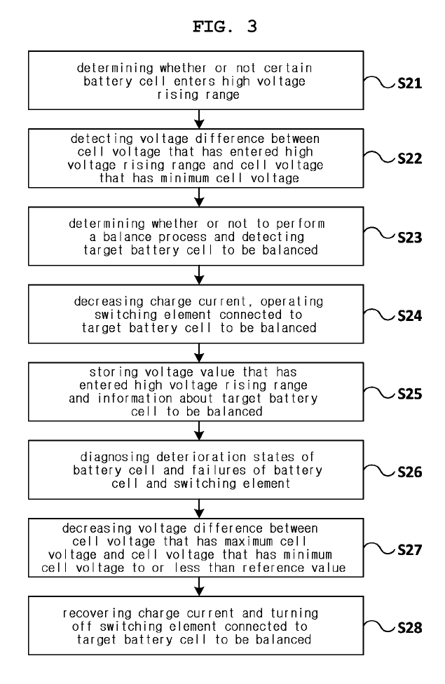

The integrated controller 14 determines whether or not to perform the balance process and detects the target battery cell to be balanced based on the cell voltage information, performs the balance process on the target battery cell to be balanced, and diagnoses a failure thereof by using information collected while the balance process is performed. An operation of the integrated controller 14 will be described in detail later with reference to FIG. 3.

First, the integrated controller 14 determines whether or not to perform the balance process and detects the target battery cell to be balanced based on the cell voltage information of the battery cells 11A and 11B. When the target battery cell to be balanced is detected, the integrated controller 14 controls the charge current controller 18 to output a signal to the charger 12, thereby the charge current supplied to the plurality battery cells 11A and 11B is decreased. At the same time, the integrated controller 14 controls the balance controller 17, thereby the switching element 16A connected to the target battery cell to be balanced (for example, first battery cell 11A) is turned on and a closed loop is formed between the first battery cell 11A, the balance resistor 15A, and the switching element 16A. Thus, the cell voltage of the first battery cell 11A is discharged by the balance resistor 15A. When decreasing the charge current and the discharging the cell voltage of the target battery cell to be balanced through the balance resistor 15A are performed at the same time while performing the balance process, since an amount of difference between the charge current and a balancing current is not large, the battery cell that belongs to the flatness range may be continuously charged and at the same time, and balance efficiency for the battery cell that belongs to the high voltage rising range may be improved.

FIG. 3 is a flowchart showing an operation of an integrated controller according to the present invention.

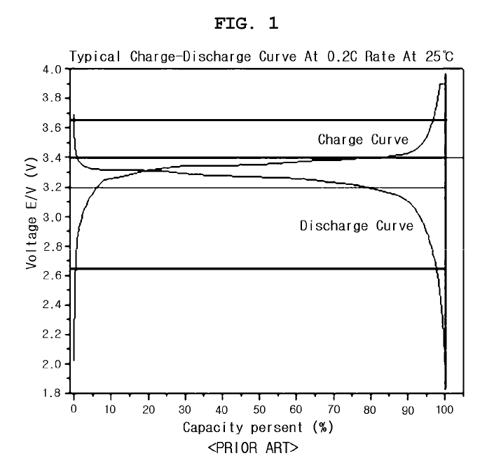

In step S21, the integrated controller 14 detects whether or not an arbitrary battery cell has exceeded the flatness range and has entered the high voltage rising range by sensing the cell voltages of the plurality of battery cells through the voltage sensor 13. In step S21, whether or not the arbitrary cell voltage of the battery cell has entered the high voltage rising range may be detected by determining whether or not the cell voltage of the arbitrary battery cell has reached a preset voltage value entering the high voltage rising range. However, in the above case, as the battery cell deteriorates, the voltage value entering the high voltage rising range also varies. Accordingly, there is a problem that the voltage value entering the high voltage rising range has to be manually and variably set according to a deterioration state of the battery cell. In order to solve the problem, in the present invention, whether or not the cell voltage of the arbitrary battery cell has entered the high voltage rising range may be detected by determining whether or not a rate of cell voltage increase in the arbitrary battery cell is equal to or greater than a threshold value. As shown in FIG. 1, in the charge characteristic curve of the lithium ion phosphate battery, a rate of cell voltage increase in the battery is very small in the flatness range. However, the rate of cell voltage increase gradually increases after entering the high voltage rising range from the flatness range. A similar pattern is maintained even though the battery deteriorates. In other words, as the battery deteriorates, the cell voltage entering the high voltage rising range varies, but, the rate of cell voltage increase in the high voltage rising range is the same.

Then, in step S22, when the arbitrary battery cell has entered the high voltage rising range, the integrated controller 14 detects a voltage difference between the cell voltage of the arbitrary battery cell that has entered the high voltage rising range and the cell voltage of a battery cell that has a minimum cell voltage.

Then, in step S23, the integrated controller 14 determines whether or not to perform the balance process and detects the target battery cell to be balanced based on the voltage difference sensed in step S22. In other words, when the voltage difference sensed in step S22 is equal to or greater than a preset threshold value, the integrated controller 14 performs the balance process and selects the arbitrary battery cell that has entered high voltage rising range as the target battery cell to be balanced.

Then, in step S24, when the balance process is performed, the integrated controller 14 decreases the charge current supplied to the plurality of battery cells 11A and 11B from the charger 12 by controlling the charge current controller 18, and turns on a switching element connected to the target battery cell to be balanced by controlling the balance controller 17. Thus, a charge voltage of the target battery cell to be balanced is consumed by an associated balance resistor.

In addition, in step S25, when the rates of cell voltage increase in the battery cells reach the respective threshold values (in other words, the battery cells have entered the high voltage rising ranges from the flatness ranges), the integrated controller 14 detects and stores voltage values at those points, in other words, the voltage values entering the high voltage rising ranges of the battery cells. In addition, in step S25, the integrated controller 14 collects and stores information about the target battery cell to be balanced.

In step S26, the integrated controller 14 detects a deterioration degree of the battery pack by detecting changes in the collected voltage values entering the high voltage rising ranges of the battery cells. When the battery cells are charged, voltage values in the same rate of the cell voltage of the battery cells increase, in other words, changes in the voltage values entering the high voltage rising ranges of the battery cells, are analyzed to calculate the deterioration degree of the battery pack. In other words, the voltage values in the rates of cell voltage increase that become references of the high voltage rising ranges are periodically collected. When a deviation from the voltage values that are initially collected is equal to or greater than a reference value, it is determined that the battery pack has begun to deteriorate. In addition, in step S26, the integrated controller 14 collects and stores the information about the target battery cell to be balanced and uses the collected information for diagnosing failures of the target battery cell to be balanced and the switching element connected thereto. For example, when the same battery cell is continuously detected as the target battery cell to be balanced for a predetermined number of times or more, a failure possibility thereof is set to be high and an alarm is given to a manager. In addition, when the switching element is turned on for a predetermined number of times or more due to the target battery cell to be balanced, a failure possibility of the corresponding switching element is also set to be high and an alarm is also given to a manager.

Then, the integrated controller 14 continuously senses changes in the cell voltages of the battery cells through the voltage sensor 13. The integrated controller 14 newly detects a target battery cell to be balanced among the remaining battery cells that enters the high voltage rising range and turns on a switching element connected thereto, thus the cell voltage of the newly detected target battery cell to be balanced is discharged by an associated balance resistor.

Meanwhile, when a voltage difference between the cell voltage of a battery cell that has a maximum cell voltage and the cell voltage of the battery cell that has the minimum cell voltage decreases to or less than a reference value in step S27, in step S28, the integrated controller 14 recovers the charge current supplied from the charger 12 to an original current level by controlling the charge current controller 18 and stops discharging the target battery cell by turning off the switching element connected thereto.

Although a preferred embodiment of the present invention has been described for illustrative purposes, but this exemplarily describes a preferred embodiment of the present invention and does not limit the present invention. Further, it is apparent to all those skilled in the art that various modifications and imitations can be made within the range without departing from the scope of the technical spirit of the present invention.

What is claimed is:

1. An apparatus for balance charging a battery pack, the apparatus comprising:
a charger supplying a charge current to a plurality of battery cells that are serially connected to each other;
a voltage sensor sensing cell voltages of the plurality of battery cells;
an integrated controller determining whether or not to perform a balance process and detecting a target battery cell to be balanced by using the sensed cell voltages of the plurality of battery cells received from the voltage sensor;
balance resistors and switching elements, each of the balance resistors and switching elements being respectively connected to the plurality of battery cells in parallel;
a balance controller, being controlled by the integrated controller, controlling a switching element connected to the target battery cell to be balanced, thereby the cell voltage of the target battery cell is consumed by an associated balance resistor; and
a charge current controller, being controlled by the integrated controller, decreasing the charge current output from the charger while the balance process is performed,
wherein the integrated controller detects whether or not the cell voltages of the battery cells enter respective high voltage rising ranges based on rates of cell voltage increase in the battery cells, controls the balance controller and the charge current controller by detecting the target battery cell to be balanced based on a voltage difference between the cell voltage of a battery cell that has entered the high voltage raising range and the cell voltage of a battery cell having a minimum cell voltage, diagnoses deterioration states of the plurality of battery cells by periodically storing voltage values entering the high voltage rising ranges corresponding to the rates of cell voltage increase in the battery cells that have entered the high voltage rising range, and diagnoses failures of the target battery cell to be balanced and the switching element connected thereto by storing information about the target battery cell to be balanced.

2. The apparatus of claim 1, wherein when a voltage difference between the cell voltage of a battery cell having a maximum cell voltage and the cell voltage of the battery cell having the minimum cell voltage decreases to or less than a reference value after performing the balance process, the integrated controller recovers the charge current to an original current level and stops discharging the target battery cell to be balanced by controlling the balance controller and the charge current controller.

3. The apparatus of claim 1, further comprising a current sensor sensing an amount of current supplied from the charger to the plurality of battery cells.

4. A method of balance charging a battery pack of an apparatus for balance charging a battery pack, whereby the apparatus includes: a charger supplying a charge current to a plurality of battery cells that are serially connected to each other; a voltage sensor sensing cell voltages of the plurality of battery cells; an integrated controller determining whether or not to perform a balance process and detecting a target battery cell to be balanced by using the sensed cell voltages of the plurality of battery cells received from the voltage sensor; balance resistors and switching elements, each of the balance resistors and switching elements respectively connected to the plurality of battery cells in parallel; a balance controller, being controlled by the integrated controller, controlling a switching element connected to the target battery cell to be balanced, thereby the cell voltage of the target battery cell is consumed by an associated balance resistor; and a charge current controller, being controlled by the integrated controller, decreasing the charge current output from the charger while the balance process is performed, the method being performed by the integrated controller and comprising:
detecting whether or not the cell voltages of the battery cells enter respective high voltage rising ranges based on rates of cell voltage increase in the battery cells;
detecting the target battery cell to be balanced based on a voltage difference between the cell voltage of a battery cell that has entered the high voltage rising range and the cell voltage of a battery cell having a minimum cell voltage;
discharging the cell voltage of the target battery cell to be balanced and decreasing the charge current by controlling the balance controller and the charge current controller when the target battery to be balanced is detected;
diagnosing deterioration states of the plurality of battery cells by periodically storing voltage values entering the high voltage rising ranges corresponding to the rates of cell voltage increase in the battery cells that have entered the high voltage rising ranges; and
diagnosing failures of the target battery cell to be balanced and the switching element connected thereto by storing information about the target battery cell.

5. The method of claim 4, wherein when a voltage difference between the cell voltage of a battery cell having a maximum cell voltage and the cell voltage of the battery cell having the minimum cell voltage decreases to or less than a reference value after discharging the cell voltage of the target battery cell to be balanced and decreasing the charge current, the integrated controller recovers the charge current to an original current level and stops discharging the target battery cell to be balanced by controlling the balance controller and the charge current controller.
